(19) United States
(12) Patent Application Publication
(10) Pub. No.: US 2018/0048693 A1
(43) Pub. Date: Feb. 15, 2018

(54) TECHNIQUES FOR SECURE DATA MANAGEMENT

(71) Applicant: The Joan and Irwin Jacobs Technion-Cornell Institute, New York, NY (US)

(72) Inventors: Rimas GULBINAS, Brooklyn, NY (US); Clay TEETER, Boise, ID (US); John A. TEETER, Oreana, ID (US)

(73) Assignee: The Joan and Irwin Jacobs Technion-Cornell Institute, New York, NY (US)

(21) Appl. No.: 15/670,651

(22) Filed: Aug. 7, 2017

Related U.S. Application Data
(60) Provisional application No. 62/372,507, filed on Aug. 9, 2016.

(51) Int. Cl. H04L 29/06; G06F 17/30; G06F 9/44; G06Q 50/26; H04L 29/08

(52) U.S. Cl. CPC H04L 65/607; G06Q 50/26; H04L 63/0428; H04L 67/12; G06F 9/44; G06F 17/30

(57) ABSTRACT

Some disclosed embodiments include a platform for secure data management and, in particular, for secure data management of smart city data. A method includes converting at least a portion of a first plurality of data streams from a plurality of data sources into an unstructured format to create a second plurality of unified format data streams; generating, based on the second plurality of unified format data streams, at least one normalized data stream, wherein each normalized data stream is one of the second plurality of unified format data streams standardized with respect to at least one standardization parameter; and generating at least one virtual meter, wherein each virtual meter is a visual representation of one of the at least one normalized data stream.

### CROSS-REFERENCE TO RELATED APPLICATIONS

This application claims the benefit of U.S. Provisional Application No. 62/372,507 filed on Aug. 9, 2016, the contents of which are hereby incorporated by reference.

### TECHNICAL FIELD

The present disclosure relates generally to urban planning of smart cities, and more specifically to managing and securing data received via various data sources in a smart city.

### BACKGROUND

Due to rapid advancements in communication technologies, solutions have developed for integrating such technologies into everyday life. Further, increasing adoption of devices such as desktop computers, laptop computers, and mobile devices, as well as the increasing use of computing devices (e.g., smart meters) in home appliances, allow for the possibility of integrating data from those devices to accomplish larger goals. In particular, the notion of “smart cities” has become realistic. Although specific definitions of smart cities vary, smart cities are generally characterized urban developments in which various information and communication technology solutions are integrated in order to manage city development and planning. Among other things, smart cities are typically utilized to improve usage of physical infrastructure, to engage with local people, and to rapidly respond to changing circumstances within the city.

Existing solutions for implementing smart cities face challenges in integrating data from a variety of sources associated with different geographic locations within the city. Additionally, existing smart city solutions often face challenges in illustrating appropriate courses of action for improvement. Existing smart city solutions typically provide data to a city planner or other person who is assigned to manage city resources. However, such provided data must typically be interpreted by the city planner in order to determine an appropriate course of action. This manual interpretation of data increases the risk of human error, limits the amount of relevant data that may be considered, and hinders addressing of problems in real-time.

Existing solutions for smart city implementations also face challenges in securely sharing information. In particular, existing solutions typically do not allow for data access by private citizens (e.g., building or property owners), and do not incorporate data from other smart cities due to concerns about data security.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for secure data management. The method comprises: converting at least a portion of a first plurality of data streams from a plurality of data sources into an unstructured format to create a second plurality of unified format data streams; generating, based on the second plurality of unified format data streams, at least one normalized data stream, wherein each normalized data stream is one of the second plurality of unified format data streams standardized with respect to at least one standardization parameter; and generating at least one virtual meter, wherein each virtual meter is a visual representation of one of the at least one normalized data stream.

Certain embodiments disclosed herein also include a non-transitory computer readable medium having stored thereon causing a processing circuitry to execute a process, the process comprising: converting at least a portion of a first plurality of data streams from a plurality of data sources into an unstructured format to create a second plurality of unified format data streams; generating, based on the second plurality of unified format data streams, at least one normalized data stream, wherein each normalized data stream is one of the second plurality of unified format data streams standardized with respect to at least one standardization parameter; and generating at least one virtual meter, wherein each virtual meter is a visual representation of one of the at least one normalized data stream.

Certain embodiments disclosed herein also include a system for secure data management. The system comprises: a processing circuitry; and a memory, the memory containing instructions that, when executed by the processing circuitry, configure the system to: convert at least a portion of a first plurality of data streams from a plurality of data sources into an unstructured format to create a second plurality of unified format data streams; generate, based on the second plurality of unified format data streams, at least one normalized data stream, wherein each normalized data stream is one of the second plurality of unified format data streams standardized with respect to at least one standardization parameter; and generate at least one virtual meter, wherein each virtual meter is a visual representation of one of the at least one normalized data stream.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a secure data manager according to an embodiment.

FIG. 3 is a flowchart illustrating a method for providing benchmarking of data streams according to an embodiment.

FIG. 4 is a flowchart illustrating a method for generating recommendations for achieving data stream goals according to an embodiment.

FIGS. 5A-5C are example screenshots illustrating sample virtual meters.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a platform for secure data management and, in particular, for secure data management of smart city data. Data streams from a plurality of sources are obtained and normalized. Based on the normalized data streams, at least one virtual meter representing the normalized data streams is generated. A report including the virtual meters may be generated. Recommendations for achieving smart city goals may be generated based on machine learning related to obtained data streams.

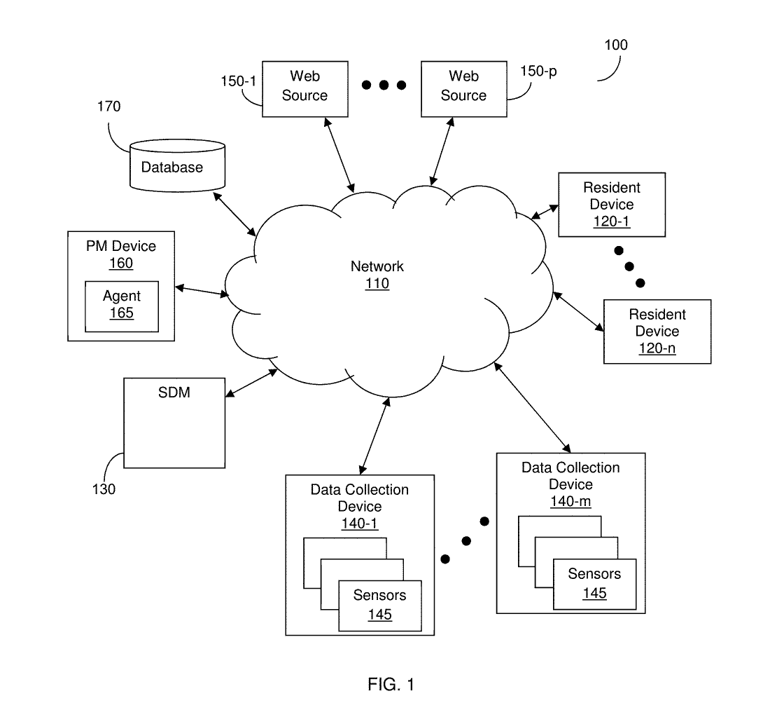

FIG. 1 shows an example network diagram 100 utilized to describe the various disclosed embodiments. A network 110 is communicatively connected to a plurality of resident devices 120-1 through 120-n (hereinafter referred to individually as a resident device 120 and collectively as resident devices 120, merely for simplicity purposes), a secure data manager (SDM) 130, and a plurality of data collection devices 140-1 through 140-m (hereinafter referred to individually as a data collection device 140 and collectively as data collection devices 140, merely for simplicity purposes), and a property manager (PM) device 160. In certain configurations, a plurality of web sources 150-1 through 150-p (hereinafter referred to individually as a web source 150 and collectively as web sources 150, merely for simplicity purposes) and a database 170 may be connected to the network 110 and may be utilized by the secure data manager 130. The network 110 may be, but is not limited to, a local area network (LAN), a wide area network (WAN), the worldwide web (WWW), the Internet, a wired network, a wireless network, similar networks, and any combinations thereof.

Each resident device 120 may be, but is not limited to, a personal computer, a laptop, a tablet computer, a smartphone, and the like. The resident device 120 is typically operable by a user who is a resident of a geographic area such as, but not limited to, a citizen of a town or city, a tenant or occupant of a building, a visitor, and the like. The resident devices 120 may be configured to receive user inputs and to send, based on the user inputs, data to the secure data manager 130. Specifically, the resident devices 120 may be configured to receive user inputs of data such as textual or other indications of user satisfaction, relative temperature (e.g., too hot, too cold, etc.) in a particular building or area, maintenance requests, transportation utilized by the user, combinations thereof, and the like.

The data collection devices 140 are configured to collect data related to activities occurring in the city. Such activities may include, but are not limited to, energy usage, waste production, and the like. Each data collection device 140 may be a smart meter or a smart appliance. Each of the data collection devices 140 may be or may include one or more sensors 145. Each of the sensors 145 may be, but is not limited to, a camera, a microphone, a temperature sensor, a proximity sensor, a gas or chemical sensor, an optical sensor, a pressure sensor, an electricity sensor, a gyroscope, an accelerometer, a Global Positioning System (GPS), and the like. The data collection devices 140 may be configured to send raw sensor data from the sensors 145, or may be configured to pre-process sensor data and to send the pre-processed data. In an embodiment, any of the data collection devices 140 may be connected or may otherwise communicate as a mesh network.

In another embodiment, the data collection devices 140 may communicate with a data collection system (not shown) over the network 110. The data collection system may be, but is not limited to, a server configured to collect various data from the data collection devices 140 and to send data streams based on the collected data to the secure data manager 130 over, e.g., the network 110. To this end, the data collection system may communicate with the secure data manager 130 via an API. The data collection system may be further configured to process the data and to send the processed data to the secure data manager 130.

The web sources 150 include any sources of data that may be relevant to urban planning of a smart city and may include, but are not limited to, web servers hosting websites, data warehouses, social media networks, and the like. The web sources 150 may be owned or operated by public or private entities, and may provide information such as building details (e.g., name, address, age, etc.), energy consumption, fuel consumption, waste, combinations thereof, and the like. To this end, the secure data manager 130 may be configured to use one or more application programming interfaces (APIs) to interface with each of the web sources 150. In a further embodiment, data from the web sources 150 may include metadata related to buildings, geographic locations, and the like. Data from the web sources 150 may further be validated. In an example embodiment, the validation may be based on at least one database schema associated with each of the web sources 150.

The property manager device 160 may be, but is not limited to, a personal computer, a laptop, a tablet computer, a smartphone, and the like. The property manager device 160 is typically operable by a user who owns, operates, manages, or otherwise at least partially controls at least one building, at least one property, or both. Such users may include, but are not limited to, landlords, owners of buildings, government officials (e.g., a city planner, a regulatory official), and the like. The property manager device 160 may be configured to request information such as benchmarking and recommendations from the secure data manager 130, and to display such requested information.

The property manager device 160 may further include an agent 165 installed therein. The agent 165 may be configured to receive user inputs and to send data to or receive data from the secure data manager 130. The user inputs may indicate, but are not limited to, selections of data streams to be normalized, goals to be met by the smart city, contextual parameters utilized to determine such goals, and the like. Specifically, the agent 165 may be further configured to receive reports, notifications, or other information from the secure data manager 130, and to cause a display of such information on the property manager device 160.

In an embodiment, a plurality of property manager devices 160 (not shown in FIG. 1) may be in communication with the secure data manager 130 to send goal or contextual parameter data and to receive reports or other information related to data streams analyzed by the secure data manager 130. In a further embodiment, each property management device 160 may be assigned a permission level such that, e.g., property management devices 160 that are assigned different permission levels may be sent or otherwise allowed to access data requiring different levels of authorization.

The disclosed embodiments allow for secure data management. To this end, in an embodiment, the secure data manager 130 is configured to receive or retrieve data streams from any of the resident devices 120, the data collection devices 140, and the web sources 150. The received or retrieved data streams may include structured data, unstructured data, semi-structured data, or a combination thereof. In another embodiment, the data streams utilized by the secure data manager 130 may be or may include virtual data (e.g., simulated data streams).

In a further embodiment, the secure data manager 130 is configured to normalize the data streams into one or more normalized data streams, thereby allowing for benchmarking. The data streams for which normalized data streams are to be generated may be selected via, e.g., inputs from the property manager device 160 and, in particular, inputs identified by the agent 165. The normalization may include, but is not limited to, merging the received or retrieved data streams into an unstructured data repository (not shown), validating the data streams, and standardizing data streams to generate at least one normalized data stream. In a further embodiment, normalizing the data streams may include combining data streams related to sensor data or other numerical values (e.g., data from the web sources 150) with user input data from the resident devices 120.

In an embodiment, each normalized data stream is standardized with respect to at least one standardization parameter. Example standardization parameters that may be used for standardization include, but are not limited to, temporal parameters (e.g., daily, weekly, monthly, annually, etc.), geographic location parameters (e.g., same building, state, or country), and the like. In a further embodiment, each normalized data stream may be standardized with respect to another data stream. As a non-limiting example, if received data streams include an hourly data stream from an electric meter (i.e., one of the data collection devices 140) and weather information from a web server of a weather forecasting company (i.e., one of the web sources 150), a normalized data stream “electrical usage with respect to weather conditions” may be generated.

In an embodiment, based on the normalized data streams, the secure data manager 130 is configured to generate at least one virtual meter. Each virtual meter is a representation of at least one normalized data stream, i.e., a series of data. Example virtual meters may illustrate, but are not limited to, energy use intensity (EUI), energy vs temperature, electric usage, natural gas usage, direct greenhouse gas (GHG) emissions, energy usage ranking scores (e.g., ENERGY STAR® scores), amount of electricity used that was purchased from a grid, amount of electricity used that was generated by onsite renewable systems, indirect GHG emissions, national median site EUI, national median source EUI, site EUI, site EUI adjusted for a current year, site energy usage, site energy usage adjusted for a current year, source EUI, source EUI adjusted for a current year, source energy usage, source energy usage adjusted for a current year, total GHG emissions, site EUI normalized for weather, site electricity usage normalized for weather, site natural gas usage normalized for weather, source EUI normalized for weather, and source energy usage normalized for weather. In an embodiment, the virtual meters may be visual representations of normalized data streams.

In an embodiment, based on the generated virtual meters, the secure data manager 130 is configured to generate a report and to send the report to, e.g., the property manager device 160.

In an embodiment, the secure data manager 130 is further configured to automatically generate recommendations for achieving goals for a smart city. The goals may be indicated directly, or may be determined based on at least one contextual parameter received from, e.g., the property manager device 160. The contextual parameters may further include one or more constraints. As a non-limiting example, user inputs may indicate that a contextual parameter sought by an owner of an apartment building is to “reduce monthly water usage in the apartment building.” The user inputs may further indicate a constraint of “reduced by at least 20%.” Based on the contextual parameter and constraint, the secure data manager 130 determines that a goal would be to achieve normalized data streams from a water flow meter indicating 20% less water consumption per month.

The recommendations may be generated based on machine learning using data of successfully met goals for the smart city or for other smart cities. The successfully met goal data may include, but is not limited to, normalized data streams created for a period of time up to and including meeting at least one goal requirement. The goal requirements may be defined via one or more goal-defining parameters indicating minimum requirements for determining that a goal has been successfully completed. In yet a further embodiment, the secure data manager 130 may be further configured to monitor results of implementing recommendations and to determine, based on the monitoring, whether the recommendations are or will likely be successful in causing the smart city to meet its goals. If the goals have not been or will not likely be met, the secure data manager 130 may be further configured to generate additional recommendations.

In various embodiments, the secure data manager 130 may be configured to automatically implement the recommendations by communicating with one or more resource devices (not shown). The resource devices may include any computerized device configured to control resources such as, but not limited to, heating or air-conditioning systems, watering systems, monitoring systems, lighting systems, security systems, robotic systems, smart grids (e.g., smart electrical grids), combinations thereof, and the like. As a non-limiting example, if a goal is to reduce annual energy consumption, one recommendation generated by the secure data manager 130 may be to dim lights on certain public walkways in a city when pedestrian traffic is typically lower. Times at which pedestrian traffic is typically lower may be determined via machine learning of motion detection sensor signals in the city.

The secure data manager 130 may be further configured to store, in the database 160, results of analyses including, but not limited to, analytics, reports, and the like. Such stored results may be utilized, long-term, for future analyses and requests for reports.

It should be understood that the embodiments disclosed herein are not limited to the specific architecture illustrated in FIG. 1, and that other architectures may be equally utilized without departing from the scope of the disclosed embodiments. Specifically, the secure data manager 130 may reside in a cloud computing platform, a datacenter, a single server or multiple servers, and the like. Moreover, in an embodiment, there may be a plurality of secure data managers operating as described hereinabove and configured to either have one as a standby, to share the load between them, or to split the functions between them. In a further embodiment, various elements of the grading system 130 may be implemented as stand-alone elements.

It should be further noted that the embodiments described herein above with regards to FIG. 1 are discussed with respect to data streams merely for simplicity purposes and without limitation on the disclosure. Other data sets, such as predetermined data sets existing in the web sources 160, may be utilized without departing from the disclosure.

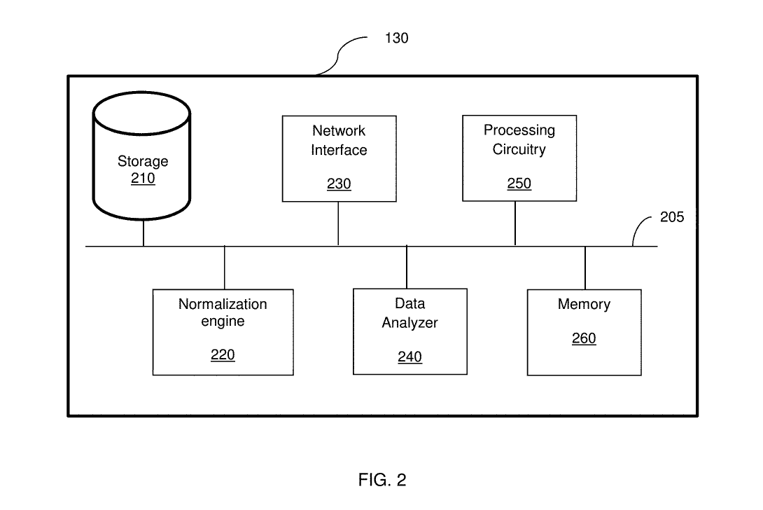

FIG. 2 is an example block diagram of the secure data manager 130 according to an embodiment. In an embodiment, the secure data manager 130 includes a storage 210, a normalization engine 220, a network interface 230, a data analyzer 240, a processing circuitry 250, and a memory 260. In an embodiment, the components of the secure data manager 130 may be connected via a bus 205.

The processing circuitry 250 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 260 may be volatile (e.g., RAM, etc.), non-volatile (e.g., ROM, flash memory, etc.), or a combination thereof. In one configuration, computer readable instructions to implement one or more embodiments disclosed herein may be stored in the storage 210.

In another embodiment, the memory 260 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 250 to perform the various processes described herein. Specifically, the instructions, when executed, cause the processing circuitry 250 to perform secure data management, as discussed hereinabove.

The storage 210 may be magnetic storage, optical storage, and the like, and may be realized, for example, as flash memory or other memory technology, CD-ROM, Digital Versatile Disks (DVDs), or any other medium which can be used to store the desired information.

The normalization engine 220 is configured to generate analytics for data streams received by the secure data manager 130 and to generate, based on the analytics, normalized data streams. The received data streams may include, but are not limited to, unprocessed or processed sensor data, textual data indicating user inputs or recommendations that were implemented, and the like. Based on the normalized data streams, the normalization engine 220 may be configured to generate at least one virtual meter representing the normalized data streams. In an embodiment, the normalization engine 220 may include an abstract machine (i.e., a Turing machine) configured to generate normalized data streams.

In an embodiment, the normalization engine 220 may be further configured to generate recommendations for achieving goals based on data streams. To this end, the normalization engine 220 may be configured to cause the data analyzer 240 to identify patterns among data streams and to determine, based on the identified patterns, one or more actions for achieving the goals. In a further embodiment, the normalization engine 220 may be configured to automatically implement the recommendations through resource devices as described further herein above. In another embodiment, the normalization engine 220 may be further configured to monitor data streams after implementation of a recommendation and to determine, based on the monitoring whether each goal has been met. If any of the goals have not been met, the normalization engine 220 may be configured to generate at least one follow up recommendation for achieving the goal.

The storage 210 may also store the results of analyses by the normalization engine 220 (e.g., generated normalized data streams and virtual meters), reports generated by the normalization engine 220, recommendations to be implemented by the normalization engine 220, a combination thereof, and the like.

The network interface 230 allows the secure data manager 130 to communicate with any of the resident devices 120, the data collection devices 140, the web sources 150, and the property manager device 160, for the purpose of, for example, receiving user interaction data, receiving sensor data, receiving user input data, sending reports, and the like.

The data analyzer 240 is configured to utilize machine learning techniques with respect to received or received data streams. In a further embodiment, the data analyzer 240 may be further configured to perform machine learning based on normalized data streams generated by the normalization engine 220. The data streams utilized by the data analyzer 240 may be stored in, but not limited to, the storage 210, the database 160, a combination thereof, and the like. Based on the data streams, the data analyzer 240 may be configured to determine associations among the data streams. The data analyzer 240 may be or may include, but is not limited to, an inference engine. The machine learning performed by the data analyzer 240 may be, but is not limited to, supervised, unsupervised, semi-supervised, reinforcement, and the like.

It should be understood that the embodiments described herein are not limited to the specific architecture illustrated in FIG. 2, and other architectures may be equally used without departing from the scope of the disclosed embodiments.

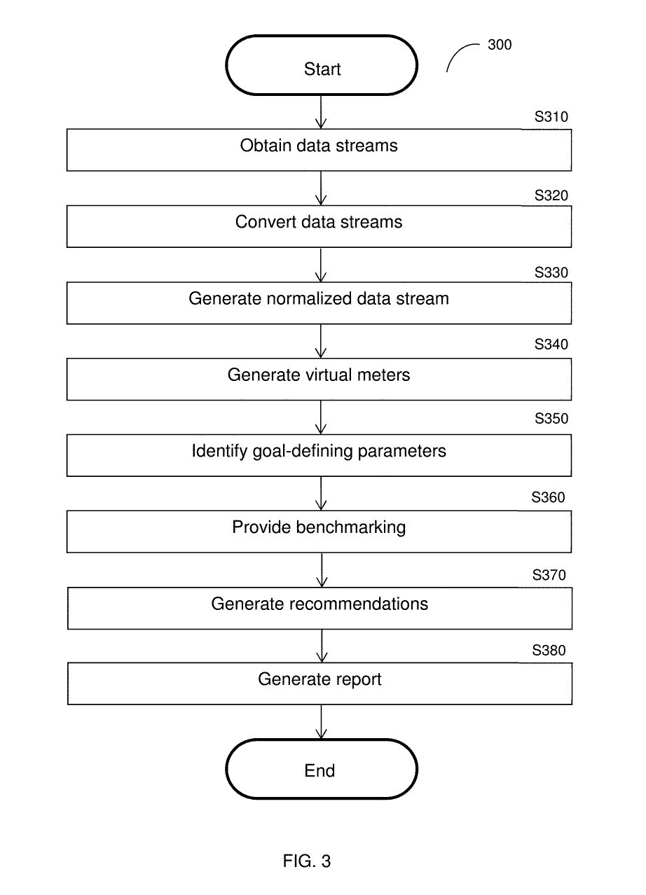

FIG. 3 is an example flowchart 300 illustrating a method for providing benchmarking of data streams according to an embodiment. In an embodiment, the method may be performed by the secure data manager 130.

At S310, a plurality of data streams is obtained. The obtained data streams may be received or retrieved from one or more resident devices (e.g., the resident devices 120), one or more data collection devices (e.g., the data collection devices 140), one or more web sources (e.g., the web sources 150), or a combination thereof. Alternatively, or collectively, the obtained data streams may be virtual data streams. The virtual data streams may be simulations or estimations of data streams. The obtained data streams may include structured, unstructured, or semi-structured data.

In particular, the obtained data streams may indicate building information (e.g., date built, name, address, history of improvements and installations, etc.), resident feedback (e.g., resident reporting of temperature, satisfaction, maintenance requests, transportation etc.), usage of resources (e.g., electricity usage, natural gas usage, fossil fuel usage, water usage, etc.), output (e.g., waste output), weather, combinations thereof, and the like.

At optional S320, at least a portion of the obtained data streams may be converted into an unstructured format. Conversion of structured and semi-structured data into an unstructured format allows for unifying data streams of varying formats. In a further embodiment, S320 may further include validating structured or semi-structured data based on a known database schema. If any of the data streams are not successfully validated, the non-validated data streams may be filtered out.

At S330, at least one normalized data stream is generated. Each normalized data stream may be based on two or more of the obtained data streams and may represent a data stream standardized with respect to one or more of the other data streams. Example data streams that may be normalized include, but are not limited to, resource usage, output, satisfaction ratings, temperature in buildings, transportation (e.g., number of residents traveling by car), and the like. Example data streams that may be utilized for standardization include, but are not limited to, time periods (e.g., hour, day, week, month, year, etc.), buildings, geographic areas (e.g., a block, a borough, etc.), building ages, weather conditions, combinations thereof, and the like. As a non-limiting example, a data stream from an electrical meter may be normalized with respect to a data stream of weather data to generate a normalized data stream indicating electrical usage relative to given weather conditions.

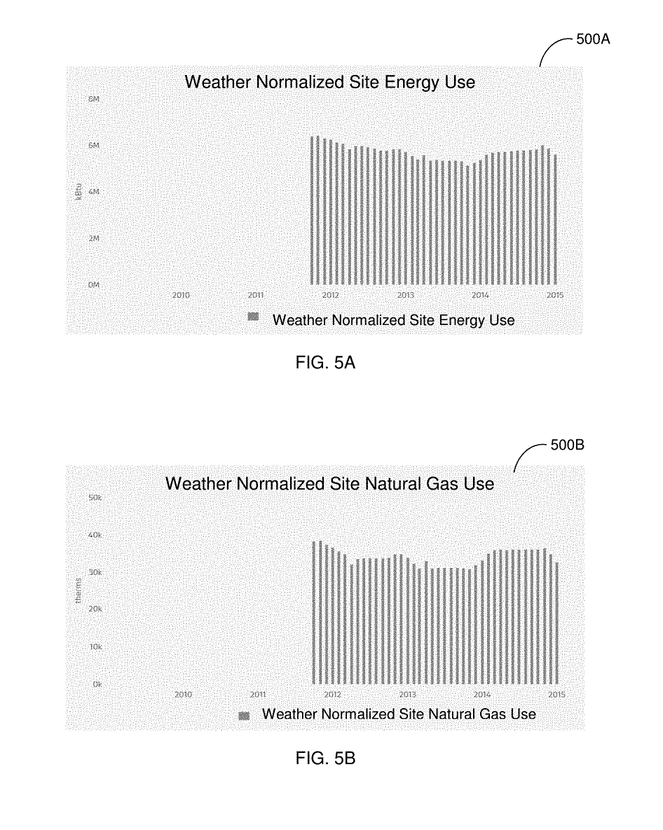

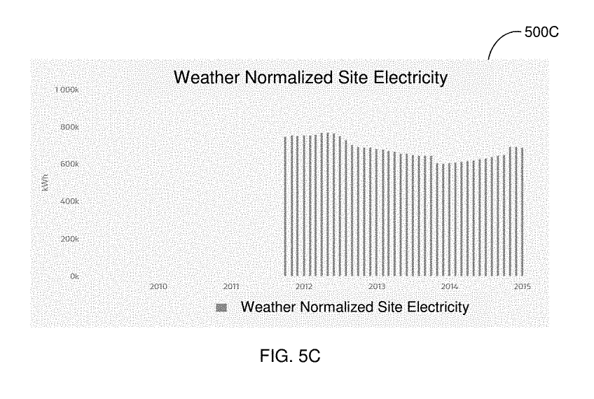

At S340, at least one virtual meter representing the at least one normalized data stream is generated. Each virtual meter may be, but is not limited to, a visual representation of a normalized data stream. Example screenshots representing virtual meters are shown herein below in FIGS. 5A-5C. The virtual meters may be displayed, e.g., on a user device, thereby allowing for securely allowing access to the normalized data streams by stakeholders such as, but not limited to, citizens, building owners, building managers, government employees, and the like. Different normalized data streams may be further associated with different levels of access such that access to particular virtual meters is limited to only certain stakeholders or groups of stakeholders.

At S350, at least one goal-defining parameter is identified. Each goal-defining parameter may be, but is not limited to, a constraint indicating a context for achieving the results (e.g., reduce energy consumption to 50% of maximum energy consumption), a goal, an identification of a building or geographic area, and the like. A constraint is a parameter or set of parameters utilized for determining goals and may be, but is not limited to, a consumption constraint (e.g., natural gas usage less than 50% of current), production constraints (e.g., produce at least twice as much solar power as current), operational constraints (e.g., garbage trucks allowed on main streets only during the hours of 6 AM to 4 PM), and the like. In an embodiment, the at least one goal-defining parameter may be included in a request. In an alternative embodiment, the goal-defining parameters may be determined automatically based on, e.g., one or more regulations; contextual parameters; constraints or goals of related buildings or geographic areas; a combination thereof; and the like.

At S360, benchmarking is provided based on the at least one goal-defining parameter and the normalized data streams. As an example, if the goal-defining parameters indicate a constraint of “reduce waste production by 40%,” the benchmarking may include normalizing the data stream “waste output” with respect to weather, a number of tenants in a building, or a combination thereof.

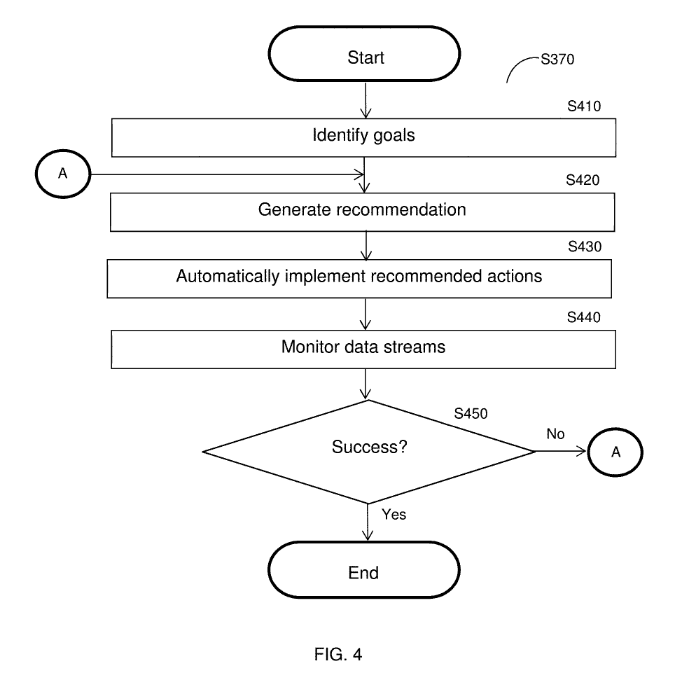

At S370, recommendations are generated how to meet a specific planning goal or goals. The operations of the S370 is discussed in more detail in FIG. 4.

At optional S380, a report may be generated. The report may include, but is not limited to, the generated at least one virtual meter, at least one visual representation of any of the obtained data streams, or both. The report may be, but is not limited to, for a particular building, for a geographic area, for a group of buildings owned or operated by the same entity, and so on. The report may further include information related to each such building.

FIG. 4 is an example flowchart S370 illustrating a method for generating recommendations for achieving planning goals of a site according to an embodiment. In an embodiment, the method may be performed by the secure data manager 130.

At S410, at least one goal is determined. In an embodiment, the at least one goal may be determined based on at least one goal-defining parameter utilized for the benchmarking. Each goal-defining parameter is utilized to define a goal for a particular building, geographic area, group of buildings, group of geographic areas, or a combination thereof. In an embodiment, each goal is determined with respect to at least one known data stream. In a further embodiment, the determination may be based on the at least one contextual parameter and the at least one constraint indicated by the request.

In another embodiment, the at least one goal may be determined further based on the data streams. Specifically, buildings or geographic areas having unusual or otherwise outlier values (e.g., as determined based on a predetermined threshold value relative to other streams) may be determined, and goals for improving performance of the building (by, e.g., reducing usage of energy or production of waste, increasing production of goods or materials, etc.). As a non-limiting example, if the data streams indicate that a particular building is above the 90th percentile for electricity usage, a goal of reducing electricity consumption for the building may be determined.

At S420, based on the determined at least one planning goal and the benchmarking, a recommendation for how to meet each planning goal is generated. Generating the recommendation may include, but is not limited to, determining at least one recommended action. In an embodiment, the recommended actions may be determined based on machine learning utilizing data streams related to the identified buildings and geographic areas, utilizing data streams related to other buildings and geographic areas, or both. In a further embodiment, the machine learning may utilize normalized data streams related to the buildings and geographic areas as determined based on the benchmarking.

The recommended actions may be events that preceded achievement of the same or a similar goal. As an example, for the goal “reduce number of lighting maintenance requests by 80%,” it may be determined that data indicating replacement of lighting fixtures with new LED fixtures caused reductions in the number of lighting maintenance requests in various buildings or geographic areas by 50%, 60%, and 90%, respectively, “replacing existing light fixtures with new LED fixtures” may be determined as a recommended action.

In an embodiment, S420 may further included sending a notification indicating the at least one recommended action. In yet a further embodiment, S420 may also include determining whether each of the at least one recommended action has been implemented and at what time each recommended action was implemented. Determining whether and when each recommended action was implemented may be based on, e.g., a response to the notification.

In another embodiment, S420 may further include generating a projected data stream based on the at least one recommended action. The projected data stream may be generated based on, e.g., machine learning related to similar or the same recommended actions implemented in other buildings or geographic areas, or the same building or geographic area.

At optional S430, the at least one recommended action may be automatically implemented. For example, if a recommended action is “reduce air conditioning usage between the hours of 10 AM-2 PM,” an air conditioning unit may be automatically caused to raise temperature during the recommended hours.

At S440, data streams related to the at least one goal may be monitored. In an embodiment, S440 may further include generating at least one progress report related to the monitored data streams. The at least one progress report may indicate a current status of progress based on the monitored data streams relative to the at least one goal. The progress report may further include virtual meters for any of the monitored data streams. For example, if a goal is “reduce energy consumption to 30%,” a progress report indicating changes in electricity consumption and natural gas consumption after implementation of the recommended actions including virtual meters for electricity consumption with respect to size of a building and natural gas consumption with respect to size of the building may be generated.

At S450, based on the monitoring, it may be determined whether the at least one recommended action was successful in achieving the goal. If so, execution terminates, otherwise, execution continues with S420. The determination in S450 may occur after, e.g., a predetermined time period, a time period specified in the goal, after occurrence of a predefined event, after occurrence of an event specified in the goal, and the like.

FIGS. 5A-5C show example screenshots 500A, 500B, and 500C, respectively, each screenshot illustrating a virtual meter. The virtual meter illustrated in screenshot 500A demonstrates the normalized data stream “Weather Normalized Site Energy Use,” which represents the total amount of energy (e.g., electricity, natural gas, fossil fuels, etc.) used monthly for a particular “site” (i.e., a building or geographic location) with respect to comparable weather conditions. As a non-limiting example, energy use may be normalized with respect to weather based at least on the average temperature for that month, as unusually warm or cold months may result in increased energy usage due to, e.g., increased reliance on heating or air conditioning systems.

The virtual meter illustrated in screenshot 500B demonstrates the normalized data stream “Weather Normalized Site Natural Gas Use,” which represents the natural gas usage for the site with respect to comparable weather conditions. Similarly, the virtual meter illustrated in screenshot 500C demonstrates the normalized data stream “Weather Normalized Site Electricity,” which represents the electricity usage for the site with respect to comparable weather conditions.

It should be noted that various embodiments are described with respect to smart cities merely for simplicity purposes and without limitation on the disclosed embodiments. The disclosed embodiments are equally applicable to other geographic areas such as, but not limited to, boroughs, states, countries, continents, planets, and any other area including multiple devices capable of collecting data streams. Further, the disclosed embodiments may be applicable to multiple cities or other geographic areas simultaneously. For example, data may be collected from various cities, and machine learning may be utilized to determine recommendations for, e.g., improving energy efficiency in a particular city based on previous reductions of energy usage in other cities.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for secure data management, comprising:
converting at least a portion of a first plurality of data streams from a plurality of data sources into an unstructured format to create a second plurality of unified format data streams;
generating, based on the second plurality of unified format data streams, at least one normalized data stream, wherein each normalized data stream is one of the second plurality of unified format data streams standardized with respect to at least one standardization parameter; and
generating at least one virtual meter, wherein each virtual meter is a visual representation of one of the at least one normalized data stream.

2. The method of claim 1, wherein the at least one standardization parameter includes at least one other data stream of the plurality of data streams.

3. The method of claim 1, further comprising:
combining at least one sensor signal data stream of the second plurality of unified format data streams with at least one user input data stream of the second plurality of unified format data streams to create at least one combination data stream, wherein the at least one normalized data stream is generated based further on the at least one combination data stream.

4. The method of claim 1, further comprising:
validating the first plurality of data streams based on at least one predetermined database schema; and
filtering any non-validated data streams of the first plurality of data streams to create a third filtered plurality of data streams, wherein the at least a portion of the second plurality of data streams includes the third filtered plurality of data streams.

5. The method of claim 1, wherein the at least one standardization parameter includes at least one goal-defining parameter, wherein each goal-defining parameter is a constraint indicating a context for achieving a result.

6. The method of claim 5, further comprising:
generating, based on the at least one normalized data stream and the at least one goal-defining parameter, at least one recommended action for achieving a goal.

7. The method of claim 6, wherein generating the at least one recommendation further comprises:
applying a machine learning model, wherein inputs to the machine learning model include the at least one normalized data stream and the at least one goal-defining parameter, wherein outputs of the machine learning model include at least one recommended action, wherein the machine learning model is trained using data streams associated with predetermined successfully met goals.

8. The method of claim 7, further comprising:
monitoring the first plurality of data streams after implementation of the at least one recommended action; and
determining, based on the monitoring, whether the at least one recommended action successfully achieved the goal.

9. The method of claim 1, wherein each of the plurality of data sources is deployed in a smart city, wherein the first plurality of data streams includes data streams indicating at least one of: building information, resident feedback, usage of resources, output, and weather.

10. A non-transitory computer readable medium having stored thereon instructions for causing a processing circuitry to execute a process, the process comprising:
converting at least a portion of a first plurality of data streams from a plurality of data sources into an unstructured format to create a second plurality of unified format data streams;
generating, based on the second plurality of unified format data streams, at least one normalized data stream, wherein each normalized data stream is one of the second plurality of unified format data streams standardized with respect to at least one standardization parameter; and
generating at least one virtual meter, wherein each virtual meter is a visual representation of one of the at least one normalized data stream.

11. A system for secure data management, comprising:
a processing circuitry; and
a memory, the memory containing instructions that, when executed by the processing circuitry, configure the system to:
convert at least a portion of a first plurality of data streams from a plurality of data sources into an unstructured format to create a second plurality of unified format data streams;
generate, based on the second plurality of unified format data streams, at least one normalized data stream, wherein each normalized data stream is one of the second plurality of unified format data streams standardized with respect to at least one standardization parameter; and
generate at least one virtual meter, wherein each virtual meter is a visual representation of one of the at least one normalized data stream.

12. The system of claim 11, wherein the at least one standardization parameter includes at least one other data stream of the plurality of data streams.

13. The system of claim 11, wherein the system is further configured to:
combine at least one sensor signal data stream of the second plurality of unified format data streams with at least one user input data stream of the second plurality of unified format data streams to create at least one combination data stream, wherein the at least one normalized data stream is generated based further on the at least one combination data stream.

14. The system of claim 11, wherein the system is further configured to:
validate the first plurality of data streams based on at least one predetermined database schema; and
filter any non-validated data streams of the first plurality of data streams to create a third filtered plurality of data streams, wherein the at least a portion of the second plurality of data streams includes the third filtered plurality of data streams.

15. The system of claim 11, wherein the at least one standardization parameter includes at least one goal-defining parameter, wherein each goal-defining parameter is a constraint indicating a context for achieving a result.

16. The system of claim 15, wherein the system is further configured to:
generate, based on the at least one normalized data stream and the at least one goal-defining parameter, at least one recommended action for achieving a goal.

17. The system of claim 16, wherein the system is further configured to:
apply a machine learning model, wherein inputs to the machine learning model include the at least one normalized data stream and the at least one goal-defining parameter, wherein outputs of the machine learning model include at least one recommended action, wherein the machine learning model is trained using data streams associated with predetermined successfully met goals.

18. The system of claim 17, wherein the system is further configured to:
monitor the first plurality of data streams after implementation of the at least one recommended action; and
determine, based on the monitoring, whether the at least one recommended action successfully achieved the goal.

19. The system of claim 11, wherein each of the plurality of data sources is deployed in a smart city, wherein the first plurality of data streams includes data streams indicating at least one of: building information, resident feedback, usage of resources, output, and weather.
